(19) United States
(12) Patent Application Publication
(10) Pub. No.: US 2017/0329153 A1
(43) Pub. Date: Nov. 16, 2017

(54) DEVICE AND METHOD FOR DIRECTLY FASTENING AT LEAST ONE TEMPLE, ENDPIECE AND/OR BRIDGE OF AN EYEGLASS FRAME ON AT LEAST ONE LENS OF RIMLESS EYEGLASSES

(71) Applicant: INOMITEC GMBH & CO. KG, Vilshofen (DE)

(72) Inventor: Michael STRENZ, Passau (DE)

(73) Assignee: INOMITEC GMBH & CO. KG, Vilshofen (DE)

(21) Appl. No.: 15/536,209

(22) PCT Filed: Dec. 21, 2015
(86) PCT No.: PCT/DE2015/100544

§ 371 Date: Jun. 15, 2017

(30) Foreign Application Priority Data
Dec. 19, 2014 (DE) 10 2014 119 288.5
Nov. 18, 2015 (DE) 10 2015 120 012.0

(51) Int. Cl. G02C 1/02

(52) U.S. Cl. CPC G02C 1/02; G02C 2200/08

(57) ABSTRACT

The invention relates to a device for directly attaching at least a temple, an endpiece and/or a bridge of a glasses frame to at least one lens of rimless glasses, in which the at least one lens includes at least one edge recess, which extends along the transverse axis (QA) of the lens, in which a fastening body is accommodated in the edge recess in a form-fitting manner and is fixedly connected to the lens. Particularly advantageously, the fastening body, comprises at least one rail-like carrier element which extends along the transverse axis (QA) to produce a detachable plug connection and the temple, the endpiece and/or the bridge of the glasses frame include at least one socket-like connection element, which has one hollow adapted to the shape and size of the rail-like carrier element.

### BACKGROUND OF THE INVENTION

The invention relates to a device for directly fastening at least one temple, endpiece and/or bridge of an eyeglass frame on at least one lens of rimless eyeglasses.

Eyeglasses without rims or so-called rimless eyeglasses already are widely known from the prior art. Such rimless eyeglasses usually comprise an eyeglass frame that comprises multiple eyeglass frame parts, preferably a bridge for connecting the two lenses in the nose region and two temples, wherein the temples are either directly connected to the lens of the rimless eyeglasses or by means of a hinge element and an endpiece. In conventional rimless eyeglasses, the free ends of the bridge and a free end of the temple or the endpiece are respectively fastened directly on the lens, namely by means of a pin element that is fixed on the respective eyeglass frame part and inserted into a bore in the lens such that the pin element can be tensioned relative to the lens on its opposite side with the aid of a fastening means.

Disadvantageously, directly fastening the eyeglass frame parts on a lens of rimless eyeglasses frequently results in damages of the lens when a force is unintentionally exerted upon the eyeglass frame. Due to the bore for accommodating the pin element, which extends through the lens in the transverse direction, the force is essentially exerted upon the lens in a punctiform fashion and therefore can lead to damages, particularly by breaking off the edge of the lens in the region of the bore.

### SUMMARY OF THE INVENTION

In light of these circumstances, one object of the invention is to provide a device for directly fastening at least one temple, endpiece and/or bridge of an eyeglass frame on at least one lens of rimless eyeglasses, by means of which the disadvantages known from the prior art are eliminated and, in particular, a stable connection between the respective eyeglass frame part and at least one lens of rimless eyeglasses can be realized.

An essential aspect of the inventive device for directly fastening at least one temple, endpiece and/or bridge of an eyeglass frame on at least one lens of rimless eyeglasses can be seen in that the fastening body comprises at least one rail-like carrier element extending along the transverse axis and the temple, endpiece and/or bridge of the eyeglass frame comprises at least one socket-like connecting element with a recess, which is adapted to the shape and size of the rail-like carrier element, in order to produce a releasable connection. In this case, it is particularly advantageous that the placement of the fastening body, which already comprises a rail-like carrier element, into the recess of the lens allows a quick and easy fastening of eyeglass frame parts directly on the lens of rimless eyeglasses. The fastening body and the associated eyeglass frame parts are preferably prefabricated with corresponding machines such that they can be assembled by the optometrist on-site without significant technical and manual effort. In addition, the risk of damaging the lenses by unintentionally exerting a force thereupon is significantly reduced due to the planar connection of the respective eyeglass frame part to the lens by means of the fastening body. Due to the releasable plug connection, it is furthermore possible to use eyeglass frames with different designs for the same lenses such that a person wearing eyeglasses can adapt, for example, the color and shape of the eyeglass frame to the current needs.

The recess of the socket-like connecting element is advantageously designed for at least sectionally accommodating the rail-like carrier element in a positive manner. The socket-like connecting element is designed such that it can be pushed on or attached to the rail-like carrier element in a direction extending parallel to the plane of the lens. In this way, a releasable plug connection can be very easily produced.

The fastening body and the rail-like carrier element are permanently or separably connected to one another. In a preferred alternative embodiment, the fastening body and the rail-like carrier element are realized integrally. For example, they may be manufactured of the same material in one production step and therefore have a particularly high durability. The fastening body and/or the rail-like carrier element may consist, for example, of metal, plastic or a combination of metal and plastic, preferably of an at least partially transparent plastic material. If the fastening body has a transparent design, the connection of the eyeglass frame to the lenses of the rimless eyeglasses is virtually invisible such that minimalistic direct fastening for rimless eyeglasses is achieved. In this way, the outside contour of the lenses is not interrupted by the fastening of the eyeglass frame, but rather preserved.

The peripheral recess preferably has a U-shaped or V-shaped cross section and is conically tapered along an axis extending perpendicular to the transverse axis and perpendicular to a lens plane containing the lenses. In this way, a particularly stable connection of the respective eyeglass frame part to at least one lens of the rimless eyeglasses is achieved.

In addition, the external shape of the fastening body is advantageously adapted to the shape of the peripheral recess, wherein the fastening body placed into the peripheral recess is flushly connected to the lens. In this way, the recess in the lens is almost completely closed and a flush lens surface is achieved. In a particularly advantageous embodiment, the fastening body placed into the peripheral recess is adhesively bonded to the lens.

The peripheral recess preferably has a U-shaped or V-shaped cross section and is conically tapered along an axis extending perpendicular to the transverse axis and perpendicular to a lens plane containing the lenses. In this way, a particularly stable connection of the eyeglass frame part to at least one lens of the rimless eyeglasses is achieved.

In a particularly advantageous embodiment, the socket-like connecting element is formed by at least a free end section of the temple, the endpiece and/or the bridge of the eyeglass frame, which are respectively made, for example, of plastic, metal or a combination of plastic and metal.

In addition, the releasable plug connection is advantageously realized in the form of a snap-in connection.

Particularly advantageously the peripheral recess is open at least toward the front side of the lens and extends over at least part of the thickness of the lens from its front side toward its rear side. In thinner lenses, the peripheral recess may also be open toward the rear side of the lens and extend over the entire thickness thereof.

The invention furthermore includes a method for directly fastening at least one temple, endpiece and/or bridge of an eyeglass frame on at least one lens of rimless eyeglasses, in which at least one peripheral recess is produced in at least one lens such that it extends along the transverse axis of the lens, and in which a fastening body is positively placed into the peripheral recess and permanently connected to the lens. An essential aspect of the inventive method can be seen in that a rail-like carrier element provided on the fastening body is plugged into a recess of a socket-like connecting element, which is adapted to the shape and size of the rail-like carrier element, in order to produce a releasable plug connection, wherein the socket-like connecting element forms part of the temple, the endpiece and/or the bridge of the eyeglass frame or the socket-like connecting element is connected to the temple, the endpiece and/or the bridge of the eyeglass frame. It is particularly advantageous if the fastening body, which is positively placed into the peripheral recess, is adhesively bonded to the lens.

In the context of the invention, the terms “approximately,” “essentially” or “about” refer to deviations from the respective exact value by +/−10%, preferably by +/−5%, and/or deviations in the form of variations that are negligible with respect to the function.

Beneficial further developments, advantages and potential applications of the invention can also be derived from the following description of exemplary embodiments and the figures.

In this context, all described and/or graphically illustrated characteristics basically form the object of the invention individually or in arbitrary combinations. In addition, the content of the claims also forms part of the description.

### BRIEF DESCRIPTION OF THE DRAWINGS

Exemplary embodiments of the invention are described in greater detail below with reference to the figures. In these figures:

FIG. 1 shows a simplified front view of inventive rimless eyeglasses with integrally designed temples;

FIG. 2 shows a simplified front view of inventive rimless eyeglasses with temples that are respectively connected to the lenses by means of a hinge element and an endpiece;

FIG. 3 shows a simplified front view of only the lenses of the rimless eyeglasses according to FIGS. 1 and 2 without eyeglass frame;

FIG. 4 shows an enlarged detail of the front side of a lens of the rimless eyeglasses according to Figure;

FIG. 5 shows a section along the axis I-I through the connecting region of the lens according to FIG. 4;

FIG. 6 shows a schematic cross section through an embodiment of the socket-like connecting element;

FIG. 7 shows a schematic side view of the recess of the socket-like connecting element;

FIG. 8 shows a schematic cross section through the fastening body, the rail-like carrier element and the socket-like connecting element pushed on the rail-like carrier element;

FIG. 9 shows a schematic side view of an embodiment of the fastening body with the rail-like carrier element;

FIG. 10 shows a schematic side view of an alternative embodiment of the fastening body with the rail-like carrier element;

FIG. 11 shows a simplified front view of only the lenses of the rimless eyeglasses without eyeglass frame, wherein the lenses comprise slot-shaped peripheral recesses;

FIG. 12 shows a side view of an alternative embodiment of a fastening body with the rail-shaped carrier element;

FIG. 13 shows a side view of another alternative embodiment of a fastening body with the rail-shaped carrier element and with a threaded pin;

FIG. 14 shows a side view of an alternative embodiment of a fastening body with a rail-shaped carrier element that has a U-shaped cross section;

FIG. 15 shows a side view of an alternative embodiment of a fastening body with a rail-shaped carrier element that has a U-shaped cross section and with a threaded pin;

FIG. 16 shows a schematic section through an inventive releasable plug connection between a rail-shaped carrier element according to FIG. 14 and a socket-like receptacle element with a recess, which is adapted to the rail-shaped carrier element;

FIG. 17 shows a schematic section through an alternative embodiment of an inventive releasable plug connection between a rail-shaped carrier element and a socket-like receptacle element with an integrated magnetic connection;

FIG. 18 shows a schematic longitudinal section through a fastening body with a carrier element that has a trapezoidal cross section;

FIG. 19 shows a schematic longitudinal section through a fastening body with a carrier element that has a cross section in the form of a partial circle;

FIG. 20 shows a schematic longitudinal section through a fastening body with a carrier element that has a cross section in the form of a partial circle and is spaced apart from the fastening body;

FIG. 21 shows a schematic top view of a two-part design of a rail-like carrier element;

FIG. 22 shows a schematic top view of an alternative embodiment of a rail-like carrier element with a central ball element;

FIG. 23 shows a schematic section through an alternative embodiment of an inventive releasable plug connection between a rail-like carrier element according to FIG. 22 and a socket-like connecting element with a recess, which is adapted to the rail-like carrier element;

FIG. 24 shows a schematic section through an alternative embodiment of a fastening body with two connecting pins; and

FIG. 25 shows a schematic section through an alternative embodiment of an inventive releasable plug connection between a rail-shaped carrier element and a socket-like connecting element with a recess, which is adapted to the rail-shaped carrier element.

### DETAILED DESCRIPTION OF THE INVENTION

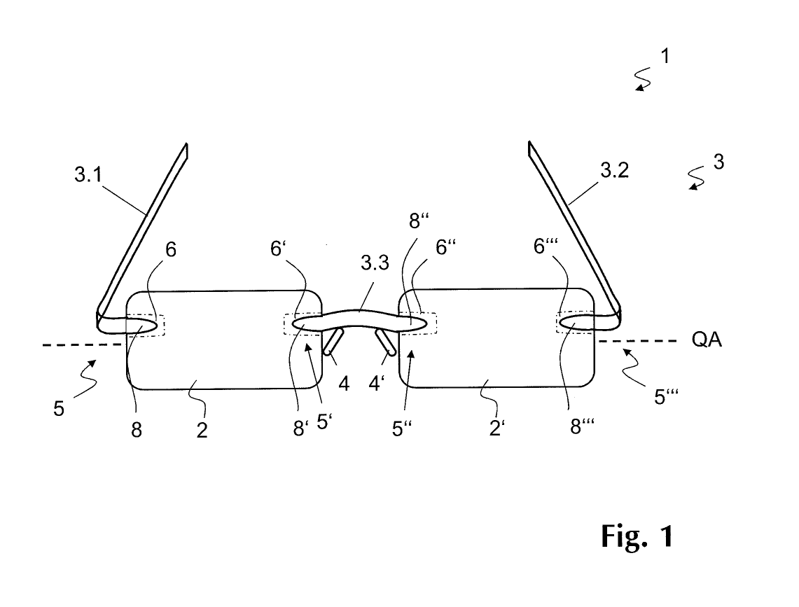

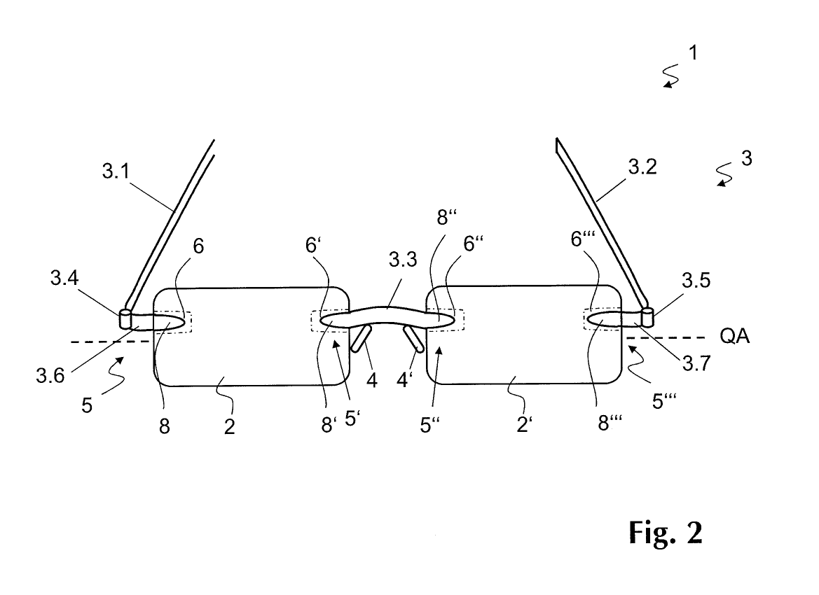

FIGS. 1 and 2 respectively show a schematic front view of exemplary rimless eyeglasses 1, which consist of two lenses 2, 2′ and an eyeglass frame 3 that comprises multiple parts.

For example, the eyeglass frame 3 illustrated in FIG. 1 comprises a first and a second temple 3.1, 3.2 and a bridge 3.3, wherein two nose pads 4, 4′ are provided on the bridge 3.3 in order to support the rimless eyeglasses 1 on the nose of the wearer. The free end of the respective temple 3.1, 3.2 is therefore directly connected to the associated lens 2, 2′.

In the embodiment according to FIG. 2, the free end of the first and the second temple 3.1, 3.2 is not directly connected to the lens 2, 2′, but rather by a first and a second hinge element 3.4, 3.5 and a first and a second endpiece 3.6, 3.7. In the present exemplary embodiment, the first hinge element 3.4 therefore produces an articulated connection between the first temple 3.1 and the first endpiece 3.6, the free end of which is referred to a front view directly connected to the left, outer lateral edge of the left lens 2 of the rimless eyeglasses 1. The second hinge element 3.5 analogously couples, in an articulated manner, the second temple 3.2 to the second endpiece 3.7, the free end of which is referred to a front view directly connected to the right, outer lateral edge of the right lens 2′ of the rimless eyeglasses 1.

The present invention is by no means limited to the embodiments of an eyeglass frame 3 illustrated in FIGS. 1 and 2, but rather also includes all embodiments of the parts of an eyeglass frame 3, which are suitable for being directly fastened on the associated lens 2, 2′ of rimless eyeglasses 1 by a free end of the respective part of the eyeglass frame 3.

The lenses 2, 2′ comprise at least one peripheral recess 5, 5′, 5″, 5′″. In the present exemplary embodiment, each lens 2, 2′ is provided with two peripheral recesses 5, 5′, 5″, 5′″ in the opposite lateral edge sections of the lens 2, 2′ in order to directly fasten the bridge 3.3, as well as the first and the second temple 3.1, 3.2 or the first and the second endpiece 3.6, 3.7, on the lenses 2, 2′.

The peripheral recesses 5, 5′, 5″, 5′″ extend along the transverse axis QA of the rimless eyeglasses 1, namely at least sectionally over the thickness S of the lens 2, 2′, i.e. from the front side 2a maximally as far as the rear side 2b of the lens 2, 2′, wherein the transverse axis QA extends in a lens plane E that contains the lenses 2, 2′. In lenses with a greater thickness S, the peripheral recesses 5, 5′, 5″, 5′″ are open at least toward the front side 2a of the lenses 2, 2′ and extend over at least one-third of the thickness S of the lenses 2, 2′ from their front side 2a toward their rear side 2b.

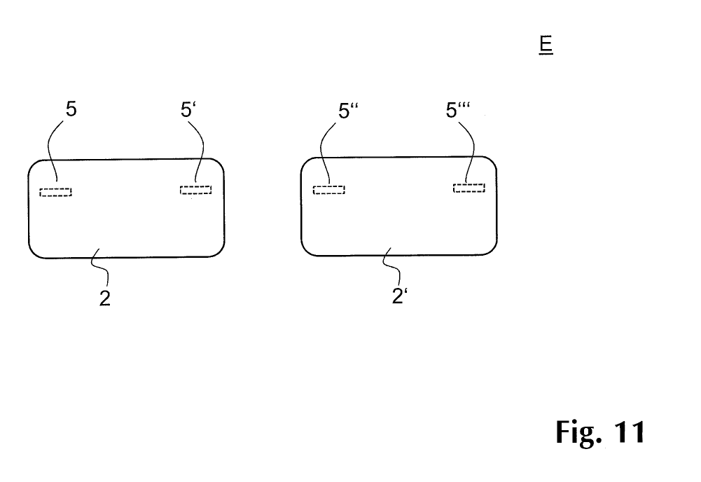

The respective peripheral recesses 5, 5′, 5″, 5′″ preferably have the same cross-sectional shape, namely a U-shaped or V-shaped or trapezoidal cross section. In the alternative embodiment according to FIG. 11, the peripheral recesses 5, 5′, 5″, 5′″ may also be realized in the form of slot-shaped or rectangular cavities that extend along the transverse axis QA and over 20% to 80% of the thickness S of the lenses 2, 2′ from their front side 2a toward their rear side 2b. The slot-shaped or rectangular cavities are completely surrounded by glass, i.e. the peripheral recesses 5, 5′, 5″, 5′″ are not open toward the edge.

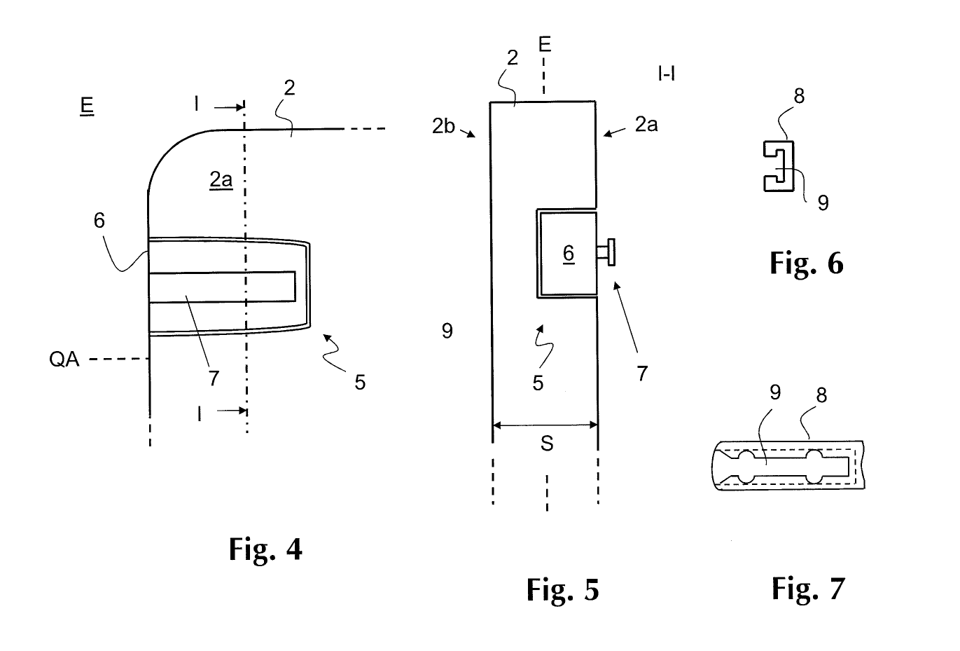

The peripheral recesses 5, 5′, 5″, 5′″ are designed for positively accommodating a fastening body 6, 6′, 6″, 6′″. The fastening body 6, 6′, 6″, 6′″, which is positively accommodated in the peripheral recess 5, 5′, 5″, 5′″, is permanently connected to the associated lens, preferably adhesively bonded or welded thereto. Different embodiments of such a fastening body 6, 6′, 6″ 6′″ are illustrated in FIGS. 4, 5, 8-10, 12-15 and 22.

In an embodiment, the fastening body 6, 6′, 6″ 6′″ is placed into the respective recesses 5, 5′, 5″, 5′″ of the lenses 2, 2′ in such a way that a flush transition is formed between the outwardly directed surfaces of the respective fastening body 6, 6′, 6″, 6″ and the adjacent surface areas of the associated lens 2, 2′, which enclose the peripheral recess 5, 5′, 5″, 5′″. The fastening body 6, 6′, 6″, 6′″ therefore completely occupies the respective recess 5, 5′, 5″, 5′″ such that a lens 2, 2′ with a closed periphery or a closed lens surface is realized.

The fastening bodies 6, 6′, 6″, 6′″ are made, for example, of metal, plastic or a combination of metal and plastic. An at least partially transparent plastic material is used in a preferred embodiment. The use of a completely transparent plastic material gives the optical impression of a closed glass surface, particularly also in the region of the recesses 5, 5′, 5″, 5′″ of the lenses 2, 2′.

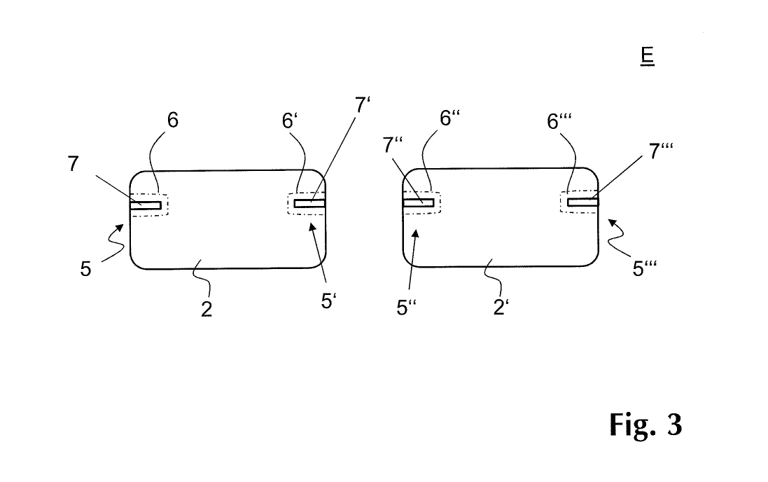

FIG. 3 shows the lenses 2, 2′ according to FIGS. 1 and 2 without an eyeglass frame 3. According to the invention, the fastening bodies 6, 6′, 6″, 6′″ are respectively provided with at least one rail-like or rail-shaped carrier element 7, 7′, 7″, 7′″ that extends along the transverse axis QA and may have various designs. In the embodiment according to FIGS. 4-10, the rail-like or rail-shaped carrier element 7, 7′, 7″, 7′″ has a T-shaped cross section. However, such a rail-like or rail-shaped carrier element 7, 7′, 7″, 7′″ may conceivably have a variety of other shapes and designs that also make it possible to produce a positive or force-fitting connection between the fastening body 6, 6′, 6″, 6′″ with the carrier element 7, 7′, 7″, 7′ and a socket-like receptacle element 8, 8′, 8″, 8′″, wherein the temple 3.1, 3.2, the endpiece 3.6, 3.7 and/or the bridge 3.3 of the eyeglass frame 3 respectively comprise at least one such socket-like connecting element 8, 8′, 8″, 8′″ with a recess 9, which is adapted to the shape and size of the rail-like or rail-shaped carrier element 7, 7′, 7″, 7′″.

FIG. 3 shows an example, in which four rail-like or rail-shaped carrier elements 7, 7′, 7″, 7′″ are provided. In this case, the fastening body 6, 6′, 6″, 6′″ and the associated rail-like carrier element 7, 7′, 7″, 7′″ may be permanently or separably connected to one another. Alternatively, the fastening body 6, 6′, 6″, 6′″ and the associated rail-like carrier element 7, 7′, 7″, 7′″ may be realized integrally. The fastening body 6, 6′, 6″, 6′″ and/or the associated rail-like or rail-shaped carrier element 7, 7′, 7″, 7′″ may furthermore be realized in the form of a single part or multiple parts. The rail-like or rail-shaped carrier element 7, 7′, 7″, 7′″, in particular, may be composed of multiple carrier sections that are realized integrally or in the form of multiple parts. These carrier sections may extend, for example, along the transverse axis QA or alternatively form multiple connecting points.

FIG. 4 shows in a top view an enlarged detail of the lateral fastening region on the front side 2a of the lens 2 according to FIGS. 1 and 2, wherein the fastening body 6 with its rail-like carrier element 7 is already accommodated in the peripheral recess 5. In this case, the surface sections of the fastening body 6 and the inner surfaces of the peripheral recess 5 of the lens positively adjoin one another and are bonded to one another.

FIG. 5 shows a section through the fastening region of the lens 2 according to FIG. 4, which contains the recess 5, along the axis I-I. The fastening body 6 is preferably accommodated in the recess 5 in such a way that its front side ends flush with the front side 2a of the lens 2 and only its rail-like carrier element 7 protrudes outward from the front side 2a. The rail-like carrier element 7 therefore forms one part of the releasable plug connection.

The other parts of the releasable plug connection are illustrated in the form of a schematic cross section and a schematic side view in FIGS. 6 and 7. FIG. 6 shows a socket-like connecting element 8, 8′, 8″, 8′″ of the temple 3.1, 3.2, the endpiece 3.6, 3.7 and/or the bridge 3.3 of the eyeglass frame 3, wherein said connecting element comprises a recess 9 that is adapted to the shape and size of the rail-like carrier element 7, 7′, 7″, 7′″.

The socket-like connecting element 8, 8′, 8″, 8′″ is preferably formed by a free end section of the temple 3.1, 3.2, the endpiece 3.6, 3.7 and/or the bridge 3.3 of the eyeglass frame 3. The socket-like connecting element 8, 8′, 8″, 8′″ or the recess 9, respectively, preferably extends along the transverse axis QA. In an embodiment, the recess 9, as well as the rail-like carrier element 7, 7′, 7″, 7′″, may have multiple snap-in positions in order to ensure that the rail-like carrier element 7, 7′, 7″, 7′″ is locked in the recess. In this case, the inventive releasable plug connection is realized in the form of a snap-in connection.

For this purpose, the recess 9 of the socket-like connecting element 8, 8′, 8″, 8′″ is designed for at least sectionally accommodating the rail-like carrier element 7, 7′, 7″, 7′″ in a positive fashion, wherein the socket-like connecting element 8, 8′, 8″, 8′″ is designed for being pushed or plugged on the rail-like carrier element 7, 7′, 7″, 7′″ in a direction extending parallel to the lens plane E of the lens 2, 2′.

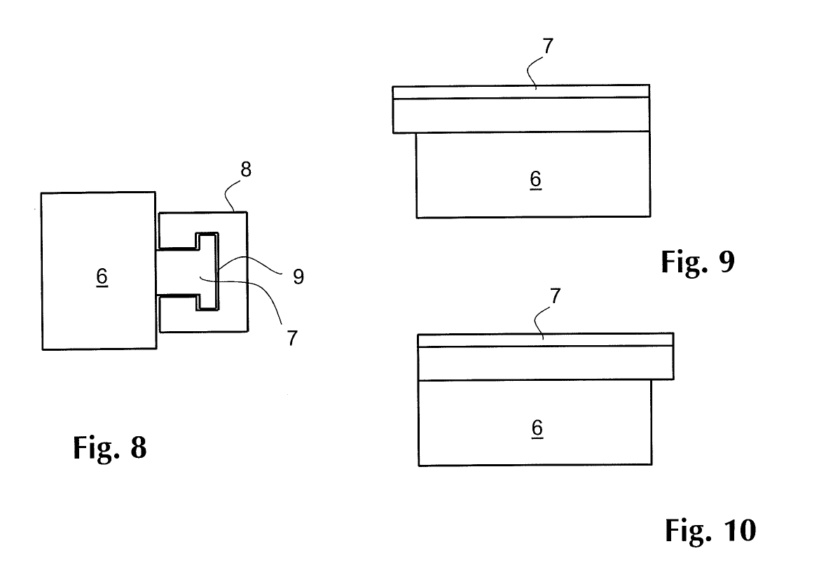

FIG. 8 shows a cross section through an exemplary rail-like carrier element 7, which is accommodated on the fastening body 6 and positively connected to the socket-like connecting element 8, wherein the socket-like connecting element 8 particularly is pushed on the rail-like or rail-shaped carrier element 7. In this case, the rail-like or rail-shaped carrier element 7 has a T-shaped cross section and the recess 9 is likewise realized with a T-shaped cross section in order to ensure a positive fit.

FIGS. 9 and 10 show different embodiments of the rail-like carrier element 7, which may be realized flush with the fastening body 6 on the face. Alternatively, the rail-like carrier element 7 may protrude outward over at least one or both faces of the fastening body 6. If the rail-like carrier element 7 protrudes over the free edge of the lens 2, 2′ in this way, the free end of the rail-like or rail-shaped carrier element 7 can be advantageously tapered in order to ensure that the socket-like connecting element 8 can be plugged on the rail-like carrier element 7 in a simplified fashion. For example, the free corner regions of a rail-like carrier element 7 with T-shaped cross section may be rounded.

FIG. 11 shows a top view of the front side 2a of two lenses 2, 2′ arranged in the lens plane E. Instead of providing peripherally open recesses 5, 5′, 5″, 5′″ as in the embodiments illustrated in FIGS. 3 and 4, the peripheral recesses 5, 5′, 5″, 5′″ are respectively realized in the form of slot-shaped or rectangular cavities and arranged in the lens 2, 2′ such that they are spaced apart from the lens edge. These slot-shaped or rectangular cavities 5, 5′, 5″, 5′″ form receptacle openings for positively accommodating the fastening bodies 6, 6′, 6″, 6′″. For this purpose, the fastening bodies are adapted to the dimensions of the slot-shaped or rectangular cavities 5, 5′, 5″, 5′″. Such slot-shaped or rectangular cavities 5, 5′, 5″, 5′″ can be easily produced in the respective lens 2, 2′ by means of a milling cutter and corresponding milling templates.

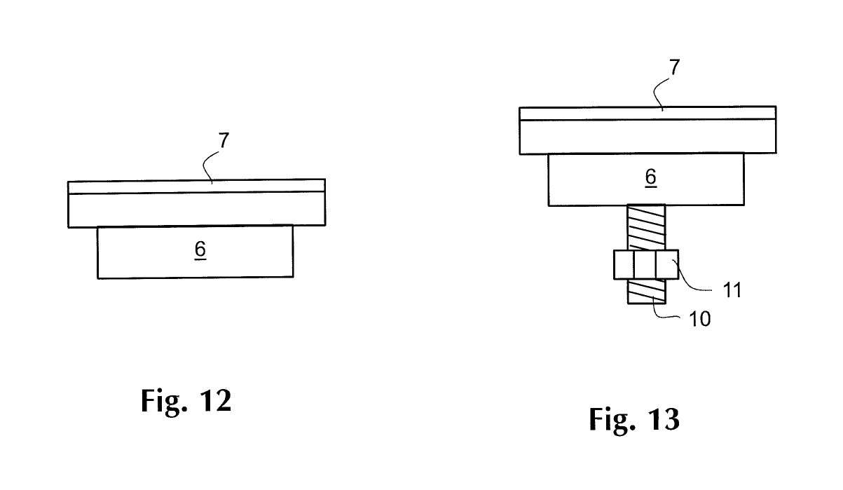

FIGS. 12 and 13 show two exemplary embodiments of a fastening body 6 that is correspondingly adapted to the slot-shaped or rectangular cavities 5, 5′, 5″, 5′″ and respectively comprises a rail-like carrier element 7 with T-shaped cross section. The fastening body 6 shown in FIG. 12 is designed, for example, for being bonded into the slot-shaped or rectangular cavities 5, 5′, 5″, 5′″. The fastening body 6 shown in FIG. 13 comprises a threaded pin 10, on which a conventional nut element 11 can be screwed, on the opposite side of the rail-like or rail-shaped carrier element 7. In order to install this fastening body on the lens 2, 2′, a through-bore is produced after the slot-shaped or rectangular cavities 5, 5′, 5″, 5′″ and the threaded pin 10 of the fastening body 6 accommodated in the slot-shaped or rectangular cavity 5, 5′, 5″, 5′″ is inserted into said through-bore and additionally fixed on the lens 2, 2′ in a conventional fashion by means of the nut element 11. In this way, a force-fitting connection, as well as a positive connection, is produced between the fastening body 6 with the rail-like or rail-shaped carrier element 7 and the lens 2, 2′.

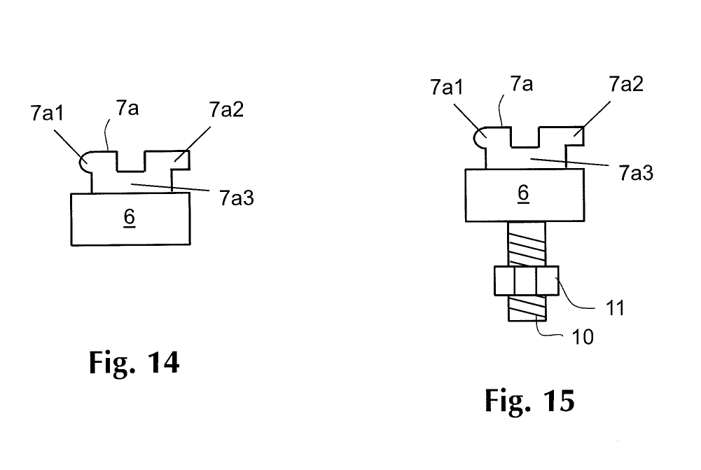

FIGS. 14 and 15 show alternative embodiments of the fastening body 6 with a rail-like carrier element 7a, wherein these fastening bodies comprise a carrier element 7a that is designed differently from the embodiments according to FIGS. 12 and 13. The fastening body 6 itself and its threaded pin 10, on which a conventional nut element 11 can be screwed, are realized analogous to the preceding description. However, the rail-like or rail-shaped carrier element 7a is formed by two opposing rail elements 7a1 and 7a2, which are configured such that the carrier element 7a has a U-shaped cross section. In this case, the two rail elements 7a1, 7a2 laterally protrude over a rail carrier 7a3, namely in the direction of the transverse axis QA or parallel to the end faces of the fastening body 6. For example, the laterally protruding or projecting ends of the two rail elements 7a1, 7a2 may be realized with a rounded or rectangular cross section. As described above, the associated fastening body 6 is—depending on the respective embodiment—either inserted into the respective slot-shaped or rectangular cavity 5, 5′, 5″, 5′″ and then bonded to the lens 2, 2′ or inserted and screwed to the lens 2, 2′, preferably in such a way that the transition area between the fastening body 6 and the carrier element 7a extends flush with the front side 2a of the lens 2, 2′.

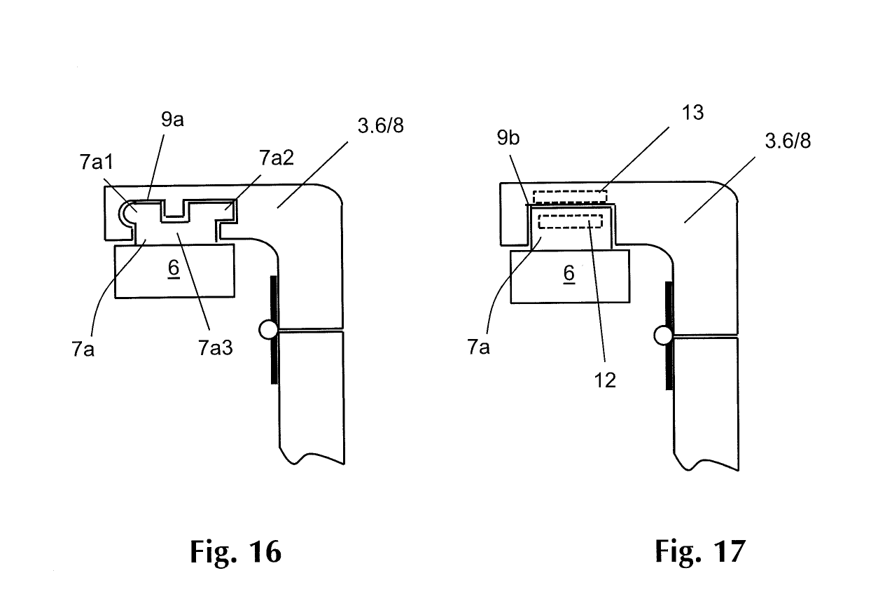

FIG. 16 shows a socket-like receptacle element 8 that is formed by the free end section of an endpiece 3.6 of an eyeglass frame 3 and comprises a recess 9a, which is adapted to the U-shaped cross section of the carrier element 7a. The recess 9a comprises two opposing recess spaces 9a1, 9a2 that are separated from one another by a projecting wall section 9a3. In the installed state, the projecting wall section 9a3 engages into the U-shaped recess between the first and the second rail element 7a1, 7a2, wherein the first recess space 9a1 preferably serves for positively accommodating the first rail element 7a1 and the second recess space 9a2 preferably serves for positively accommodating the second rail element 7a2. The socket-like receptacle element 8 is positively attached and snapped on the carrier element 7a with U-shaped cross section by a respective rotating or pivoting motion.

FIG. 17 shows an alternative embodiment of such an inventive releasable plug connection, which does not comprise any laterally protruding “snap-in projections” or carrier elements 7a1, 7a2, but rather comprises a block-like carrier element 7a that protrudes from the fastening body 6, wherein said carrier element engages into a correspondingly designed recess 9b of the socket-like receptacle element 8 and preferably is positively accommodated therein. In this case, a magnetizable component 12 and/or a magnet 13 may be accommodated either in the respective socket-like receptacle element 8 or free end section of the temple 3.1, 3.2, endpiece 3.6, 3.7 and/or bridge 3.3 of the eyeglass frame 3 or in the rail-like or rail-shaped carrier element 7 in order to produce a non-positive connection between the aforementioned components. The magnetizable component 12 may consist of a small metal plate or metal rod that is integrally cast into the eyeglass frame. The magnet 13 is realized, for example, in the form of a permanent magnet or bar magnet that is accommodated in the rail-like or rail-shaped carrier element 7a or arranged thereon. Vice versa, the magnet may be accommodated or arranged in the socket-like receptacle element 8 and the rail-like or rail-shaped carrier element 7a may, for example, be made of metal or comprise an integral magnetizable component 12.

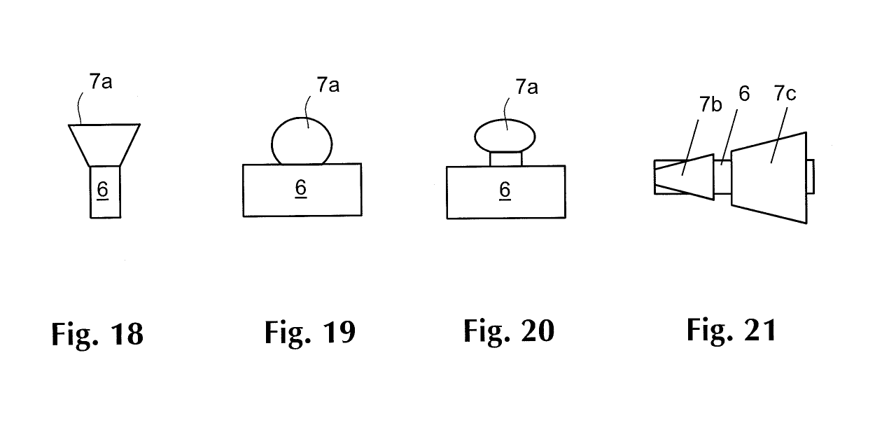

FIGS. 18 to 21 show different embodiments of the essentially rail-like or rail-shaped carrier element 7a, in which the fastening body 6 essentially has the same shape. FIG. 18 shows a side view of a fastening body 6 with a rail-like or rail-shaped carrier element 7a that has a trapezoidal or V-shaped cross section. FIGS. 19 and 20 show a fastening body 6 with a rail-like or rail-shaped carrier element 7a that has a cross section in the form of a circle or at least a partial circle, wherein the circular or at least partially circular rail-like or rail-shaped carrier element 7a is connected to the fastening body 6 either directly or spaced apart by means of a connecting web. FIG. 21 shows a top view of an exemplary rail-like or rail-shaped carrier element with preferably trapezoidal first and second carrier element sections 7b, 7c, which are arranged adjacent to one another along the longitudinal axis of the fastening body 6 or the transverse axis QA of the eyeglasses 1, respectively.

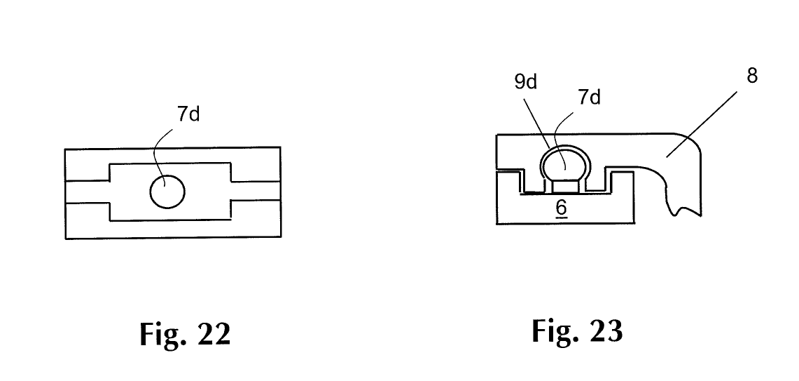

FIGS. 22 and 23 show another alternative embodiment of an inventive fastening body 6 with an alternatively designed rail-like or rail-shaped carrier element 7d, as well as an associated socket-like receptacle element 8 with a correspondingly designed recess 9d. In this case, the rail-like or rail-shaped carrier element 7d comprises, for example, a central ball element that is centrally accommodated in a rectangular recess. The complementary design of the recess 9d allows one to positively attach the socket-like receptacle element 8 on the rail-like or rail-shaped carrier element 7d.

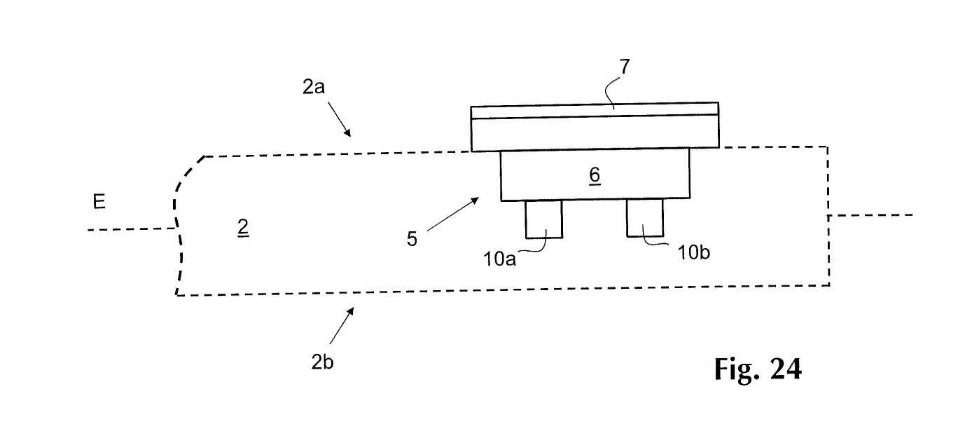

FIG. 24 shows another alternative embodiment of a fastening body 6 that comprises a rail-like or rail-shaped carrier element 7, for example on its upper side. In this case, the rail-like or rail-shaped carrier element 7 may have any of the cross-sectional shapes described above, designed for laterally attaching an associated socket-like receptacle element 8 with a correspondingly designed recess 9. In contrast to the above-described exemplary embodiments, at least one connecting pin, preferably two connecting pins 10a, 10b, are provided on the underside of the fastening body 6 and perpendicularly protrude from the underside of the fastening body 6. These connecting pins 10a, 10b are spaced apart from one another and preferably realized integrally or in one piece with the rail-like or rail-shaped carrier element 7. According to FIG. 24, these connecting pins engage into correspondingly shaped bores or holes of the peripheral recesses 5 in the lens 2. The connecting pins 10a, 10b are preferably realized cylindrically and engage into correspondingly shaped cylindrical bores adjacent to the peripheral recess 5. However, the ends of the bores are spaced apart from the rear side 2b, i.e. the bores only extend toward the rear over part of the lens 2 adjacent to the peripheral recesses 5.

In another advantageous embodiment, the underside of the fastening body 6 and/or the edge section of the fastening body 6 accommodated in the peripheral recess 5 is profiled in order to additionally increase the adhesion of the adhesive connection between the lens 2 and the fastening body 6.

In another embodiment, the connecting pins 10a, 10b of the fastening body 6 may also comprise channel-shaped recesses that extend along the longitudinal pin axis and allow at least part of the adhesive filled into the bores to flow in the direction of the underside of the fastening body 6 when the connecting pins 10a, 10b are inserted into said bores. Additionally or alternatively, the diameter of the connecting pins 10a, 10b may vary, for example increase or decrease, along the longitudinal pin axis and/or the free end of the connecting pins 10a, 10b facing away from the fastening body 6 may be beveled.

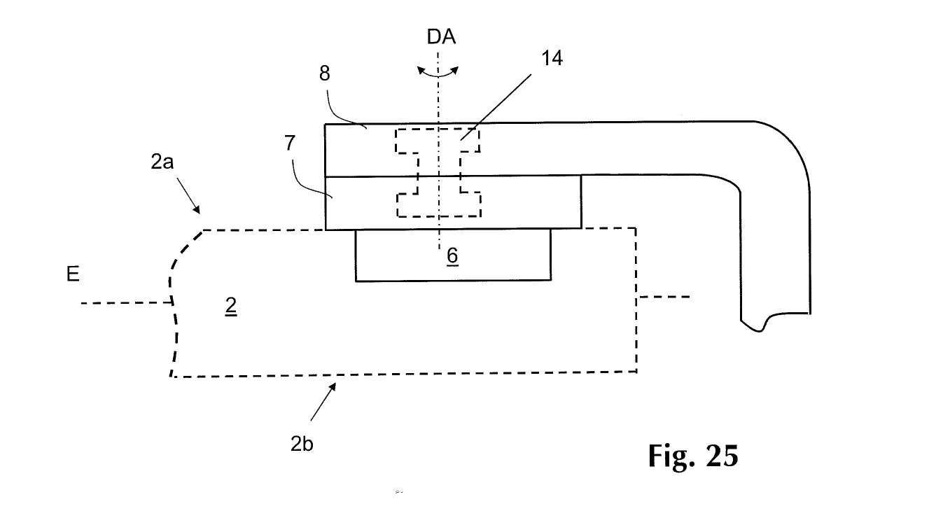

Lastly, FIG. 25 shows another embodiment of the inventive plug connection between the rail-like or rail-shaped carrier element 7 and the associated socket-like receptacle element 8 with a correspondingly designed recess 9. In this case, a locking element 14 is accommodated either in the carrier element 7 and/or in the fastening body 8 and/or in the socket-like receptacle element 8 such that it is rotatable or pivotable about a rotation axis DA, wherein the rotation axis DA extends perpendicular to the lens plane E. The plug connection produced between the rail-like or rail-shaped carrier element 7 and the socket-like receptacle element 8 can be locked by rotating the aforementioned locking element about the rotation axis DA, preferably by 90° or 180°, and thereby transferring the locking element from a release position into a locking position and vice versa. For this purpose, the locking element 14 comprises on its free end at least one locking tab, preferably two locking tabs that are brought in contact with and engage behind correspondingly shaped contact surfaces in such a way that a displacement in the direction of the rotation axis DA is no longer possible. In this case, the at least one locking element 14 can be inserted into correspondingly shaped recesses or passage openings in the carrier element 7 and/or the fastening body 6 or the socket-like receptacle element 8 from above along the rotation axis DA and is rigidly accommodated therein after a rotation or pivoting motion into the locking position such that a motion along the rotation axis DA is no longer possible. The locking element 14 therefore blocks the plug connection from being unintentionally displaced along the lens plane E.

The invention was described above with reference to exemplary embodiments. It goes without saying that numerous changes and modifications are possible without thereby deviating from the inventive concept.

### REFERENCE LIST

1 Rimless eyeglasses
2, 2′ Lenses
2a Front side
2b Rear side
3 Eyeglass frame
3.1 First temple
3.2 Second temple
3.3 Bridge
3.4 First hinge element
3.5 Second hinge element
3.6 First endpiece
3.7 Second endpiece
4, 4′ Nose pads
5, 5′, 5″, 5′″ Peripheral recess
6, 6′, 6″, 6′″ Fastening body
7, 7′, 7″, 7′″ Rail-like carrier element
7a-7d Alternative rail-like carrier elements
8, 8′, 8″, 8′″ Socket-like receptacle element
9, 9a-9d Recess or recess section
10 Threaded pin
10a, b Connecting pin
11 Nut element
12 Magnetizable component
13 Magnet
14 Locking element
DA Rotational axis
QA Transverse axis
E Lens plane
S Lens thickness

1. A device for directly fastening at least one temple, endpiece and/or bridge of an eyeglass frame on at least one lens of rimless eyeglasses, wherein the at least one lens comprises at least one peripheral recess extending along a transverse axis (QA) of the at least one lens, and wherein a fastening body is positively accommodated in the at least one peripheral recess and permanently connected to the at least one, wherein the fastening body comprising at least one rail carrier element extending along the transverse axis (QA) and the at least one temple, the endpiece and/or the bridge of the eyeglass frame comprises at least one socket connecting element with a recess, which is adapted to the shape and size of the rail carrier element to produce a separable plug connection.

2. The device according to claim 1, wherein the at least one recess of the socket connecting element at least sectionally accommodates the rail carrier element in a positive fashion.

3. The device according to claim 1, wherein the socket connecting element can be pushed or plugged on the rail carrier element in a direction extending parallel to a plane (E) of the at least one lens.

4. The device according to claim 1 wherein the fastening body and the rail carrier element are permanently or separably connected to one another.

5. The device according to claim 1, wherein the fastening body and the rail carrier element are realized integrally.

6. The device according to claim 1, wherein the rail carrier element has a T-shaped cross section.

7. The device according to claim 1, wherein the fastening body and/or the rail carrier element are made of metal, plastic or a combination of metal and plastic.

8. The device according to claim 1, wherein the at least one peripheral recess has a U-shaped or V-shaped cross section.

9. The device according to claim 8, wherein the external shape of the fastening body is adapted to the shape of the at least one peripheral recess.

10. The device according to claim 1, wherein the fastening body placed into the at least one peripheral is flushly connected to the at least one lens.

11. The device according to claim 1, wherein the fastening body placed into the at least one peripheral recess is bonded to the at least one lens.

12. The device according to claim 1, wherein the at least one peripheral recess is conically tapered along an axis extending perpendicular to the transverse axis (QA) and perpendicular to a lens plane (E) containing the at least one lens.

13. The device according to claim 1, wherein the socket connecting element is formed by at least a free end section of the at least one temple, the endpiece and/or the bridge of the eyeglass frame.

14. The device according to claim 1, wherein at least one the temple, the endpiece and/or the bridge of the eyeglass frame are made of plastic, metal or a combination of plastic and metal.

15. The device according to claim 1, wherein the separable plug connection is a snap-in connection.

16. The device according to claim 1, wherein the at least one peripheral recess is open at least toward a front side of the at least one lens and extends over at least part of a thickness (S) of the at least one lens from the front side toward a rear side.

17. The device according to claim 16, wherein the at least one peripheral recess is also open toward the rear side of the at lest one lens and extends over an entire thickness (S) of the at lest one lens.

18. A method for directly fastening at least one temple, endpiece and/or bridge of an eyeglass frame on at least one lens of rimless eyeglasses, wherein at least one peripheral recess is produced in the at least one lens such that a fastening body extends along a transverse axis (QA) of the at lest one lens, and wherein the fastening body is positively placed into the at least one peripheral recess and permanently connected to the at least one lens, wherein a rail carrier element provided on the fastening body is plugged into a recess of a socket connecting element, which is adapted to a shape and a size of the rail carrier element, in order to produce a separable plug connection, wherein the socket connecting element forms part of the at least one temple, the endpiece and/or the bridge of the eyeglass frame or the socket connecting element which is connected to the at lest one temple, the endpiece and/or the bridge of the eyeglass frame.

19. The method according to claim 18, wherein the fastening body, which is positively placed into the peripheral recess, is bonded to the at least one lens.
